(19) United States
(12) Patent Application Publication
(10) Pub. No.: US 2021/0002412 A1
(43) Pub. Date: Jan. 7, 2021

(54) METHOD FOR PRODUCING POLYURETHANE SOFT FOAMS WITH HIGH BULK DENSITY

(71) Applicant: Covestro Intellectual Property GmbH & Co. KG, Leverkusen (DE)

(72) Inventors: Matthaeus Gossner, Köln (DE); Veronica-Alina Faerber, Bergisch Gladbach (DE); Lutz Brassat, Leverkusen (DE)

(21) Appl. No.: 16/980,891

(22) PCT Filed: Mar. 21, 2019
(86) PCT No.: PCT/EP2019/057113

§ 371 Date: Sep. 15, 2020

(30) Foreign Application Priority Data
Mar. 22, 2018 (EP) 18163429.6

(51) Int. Cl. C08G 18/48; C08G 18/18; C08G 18/22; C08G 18/20; C08G 18/76

(52) U.S. Cl. CPC C08G 18/4837; C08G 18/1833; C08G 2101/0008; C08G 18/2027; C08G 18/7621; C08G 18/222

(57) ABSTRACT

The invention relates to a method for producing polyurethane soft foams having a volumetric weight according to DIN EIN ISO 845: 2009-10 from 50.0 to 80.0 kg/m³, in particular open-cell polyurethane soft foams based on polyether polyol and toluylene diisocyanate, having a high bulk density, wherein the resulting polyurethane foams have similar properties to the already known polyurethane soft foams, these being simpler and more sustainable in terms of their production.

The present invention relates to a process for producing flexible polyurethane foams having a density in accordance with DIN EN ISO 845:2009-10 from 50.0 to 80.0 kg/m³ and for polyether polyol- and tolylene diisocyanate-based open-cell flexible polyurethane foams having high bulk density in particular; the resulting polyurethane foams have similar properties to already known flexible polyurethane foams, but the production thereof is easier and more sustainable.

In order to obtain polyether polyol- and tolylene diisocyanate-based flexible foams having a desired open-cell structure, two different batches of tolylene diisocyanate mixtures have been used thus far. The first batch is a mixture of 80% by weight of tolylene 2,4-diisocyanate and 20% by weight of tolylene 2,6-diisocyanate obtainable in a simple preparation, this being nitration followed by reduction to the amine and phosgenation. The second mixture consists of 67% by weight of tolylene 2,4-diisocyanate and 33% by weight of tolylene 2,6-diisocyanate and requires a costly and laborious workup in order to obtain the higher content of tolylene 2,6-diisocyanate. In this method, tolylene diisocyanate is crystallized out of the mixture in order to increase the proportion of tolylene 2,6-diisocyanate. The higher content of tolylene 2,6-diisocyanate is necessary in order to increase the content of this compound in the reaction for the flexible polyurethane foams. The higher content of tolylene 2,6-diisocyanate is in turn necessary in order to obtain the desired open-cell structure.

It was therefore an object of the present invention to find a system for producing flexible foams of high bulk density in which the use of the batch of tolylene diisocyanate mixture worked up by means of crystallization can be reduced or avoided altogether.

The inventors of the present invention have surprisingly found that this is possible by using specific carboxylic esters of the present invention.

The object of the present invention is achieved by a process for producing polyurethane foams having a density in accordance with DIN EN ISO 845:2009-10 from 50.0 to 80.0 kg/m³ through the reaction of

component A) comprising one or more polyether polyols A1,
B) optionally
B1) catalysts, and/or
B2) auxiliaries and additives,
   C) water and/or physical blowing agents,
   with
   D) di- and/or polyisocyanates,
   wherein production is carried out at an index of 90 to 120,
   characterized in that production takes place in the presence of at least one compound E that has the formula (I) below:

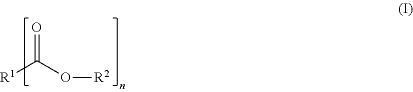

where
R¹ is an aromatic hydrocarbon radical having at least 5 carbon atoms or is a linear, branched, substituted or unsubstituted aliphatic hydrocarbon radical having at least 2 or, if branched, at least 3 carbon atoms;
R² is a linear, branched, substituted or unsubstituted aliphatic hydrocarbon radical; and
n is 1 to 3.

Where it is stated in the present invention that a particular compound or radical may be substituted, this means that substituents known to those skilled in the art are used therefor. In the compounds, it is particularly preferable that one or more hydrogen atoms are replaced by —F, —Cl, —Br, —I, —OH, ═O, —OR³, —OC(═O)R³, —C(═O)—R³, —NH₂, —NHR³, —NR³₂, where R³ represents a linear alkyl radical having 1 to 10 carbon atoms or a branched alkyl radical having 3 to 10 carbon atoms. Particular preference is given to —F, —Cl, —OR³, —OC(═O)R³, and —C(═O)—R³ substituents, where R³ represents a linear alkyl radical having 1 to 10 carbon atoms or a branched alkyl radical having 3 to 10 carbon atoms.

In particular, the present invention relates to:
1. A process for producing polyurethane foams having a density in accordance with DIN EN ISO 845:2009-10 from 50.0 to 80.0 kg/m³ through the reaction of
   component A) comprising one or more polyether polyols A1, in particular having a hydroxyl value in accordance with DIN 53240-1:2013-06 from 20 mg KOH/g to 250 mg KOH/g, preferably 40 to 60 mg KOH/g, and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight (component A1), wherein the polyether polyols A1 are preferably free of carbonate units,
   B) optionally
      B1) catalysts, and/or
      B2) auxiliaries and additives,
   C) water and/or physical blowing agents,
   with
   D) di- and/or polyisocyanates that comprise or consist of tolylene 2,4-diisocyanate and tolylene 2,6-diisocyanate;
   wherein production is carried out at an index of 90 to 120, preferably 100 to 115, more preferably at 102 to 110,
   characterized in that production takes place in the presence of at least one compound E that has the formula (I) below:

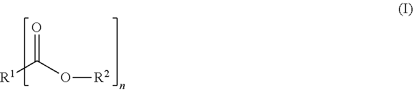

where
R¹ is an aromatic hydrocarbon radical having at least 5 carbon atoms or is a linear, branched, substituted or unsubstituted aliphatic hydrocarbon radical having at least 2 or, if branched, at least 3 carbon atoms;
R² is a linear, branched, substituted or unsubstituted aliphatic hydrocarbon radical; and n is 1 to 3.
2. The process as claimed in aspect 1, characterized in that in formula (I)
   R¹ is an aromatic hydrocarbon radical having at least 6 carbon atoms or is a linear, branched, substituted or unsubstituted aliphatic hydrocarbon radical having at least 3, preferably 3 to 10 carbon atoms;
   R² is a linear, branched, substituted or unsubstituted aliphatic hydrocarbon radical having at least 3, preferably 3 to 16 carbon atoms; and
   n is 1 to 3;
   R¹ is preferably an aromatic hydrocarbon radical having 6 carbon atoms or a linear, branched, substituted or unsubstituted aliphatic saturated hydrocarbon radical having at least 3, preferably 3 to 10 carbon atoms;
   more preferably, the compound is an ester of an optionally substituted C₃₋₁₂ monocarboxylic acid esterified with a linear or branched C₃₋₁₆ alkyl alcohol, in particular hexyl hexanoate;
   or an ester of an optionally substituted C₄₋₁₂, more preferably C₆₋₁₀, dicarboxylic acid esterified with a linear or branched C₃₋₁₆ alkyl alcohol, in particular one selected from bis(2-ethylhexyl) adipate and diisodecyl sebacate;
   or an ester of an optionally substituted C₅₋₁₆, more preferably C₆₋₁₀, dicarboxylic acid esterified with a linear or branched C₃₋₁₆ alkyl alcohol, in particular one selected from tris(2-ethylhexyl) O-acetylcitrate, and tributyl O-acetylcitrate;
   or an ester of a mono-, di- or trisubstituted benzene bearing a carboxylic acid group esterified with a linear or branched C₃₋₁₆ alkyl alcohol, in particular esters of C₆₋₁₆ alkyl alcohols and trimesic acid or trimellitic acid, particularly preferably tris(2-ethylhexyl) trimellitate.
3. The process as claimed in aspect 1 or 2, characterized in that component A has the following composition:
   A1 40 to 100 parts by weight, preferably 70 to 98 parts by weight, more preferably 90 to 95 parts by weight, of one or more polyether polyols having a hydroxyl value in accordance with DIN 53240-1:2013-06 from 20 mg KOH/g to 250 mg KOH/g, preferably 40 to 60 mg KOH/g, and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight, wherein the polyether polyols A1 are preferably free of carbonate units,
   A2 0 to 60 parts by weight, preferably 0.1 to 20 parts by weight, of one or more polyether carbonate polyols having a hydroxyl value in accordance with DIN 53240-1:2013-06 from 20 mg KOH/g to 120 mg KOH/g,
   A3 0 to 60 parts by weight, preferably 0.1 to 20 parts by weight, based on the sum of the parts by weight of components A1 and A2, of one or more polyether polyols having a hydroxyl value in accordance with DIN 53240-1:2013-06 from 20 mg KOH/g to 250 mg KOH/g and an ethylene oxide content of at least 60% by weight, wherein the polyether polyols A3 in particular are free of carbonate units,
   A4 0 to 40 parts by weight, preferably 0.1 to 30 parts by weight, based on the sum of the parts by weight of components A1 and A2, of one or more polymer polyols, PUD polyols, and/or PIPA polyols,
   A5 0 to 40 parts by weight, preferably 0.1 to 25 parts by weight, based on the sum of the parts by weight of components A1 and A2, of polyols that do not come under the definition of components A1 to A4, wherein all stated parts by weight of components A1, A2, A3, A4, A5 are normalized so that the sum of the parts by weight of A1+A2 in the composition is 100.
4. The process as claimed in any of the preceding aspects, characterized in that the at least one compound E is used in an amount of 1.0 to 15.0, preferably 2.5 to 10.0, more preferably 5 to 8, parts by weight, wherein all stated parts by weight of compound E are based on 100 parts by weight of component A1.
5. The process as claimed in any of the preceding aspects, characterized in that the following are used as component B:
   B1 catalysts such as
   a) aliphatic tertiary amines, cycloaliphatic tertiary amines, aliphatic amino ethers, cycloaliphatic amino ethers, aliphatic amidines, cycloaliphatic amidines, urea and urea derivatives, and/or
   b) tin(II) salts of carboxylic acids and
   B2 optionally auxiliaries and additives.
6. The process as claimed in any of the preceding aspects, characterized in that component A comprises:
   A1 65 to 95 parts by weight, of one or more polyether polyols having a hydroxyl value in accordance with DIN 53240 from 20 mg KOH/g to 250 mg KOH/g, preferably 40 to 60 mg KOH/g, and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight, wherein the polyether polyols A1 are free of carbonate units, and
   A2 5 to 35 parts by weight of one or more polyether carbonate polyols having a hydroxyl value in accordance with DIN 53240-1:2013-06 from 20 mg KOH/g to 120 mg KOH/g or
   A3 5 to parts by weight of one or more polyether polyols having a hydroxyl value in accordance with DIN 53240-1:2013-06 from 20 mg KOH/g to 250 mg KOH/g and an ethylene oxide content of at least 60% by weight.
7. The process as claimed in any of the preceding aspects, characterized in that component A2 comprises a polyether carbonate polyol obtainable by copolymerization of carbon dioxide and one or more alkylene oxides in the presence of one or more H-functional starter molecules, wherein the polyether carbonate polyol preferably has a CO₂ content from 15% to 25% by weight.
8. The process as claimed in any of the preceding aspects, characterized in that component D comprises at least 50% by weight, preferably at least 80% by weight, of tolylene 2,4-diisocyanate and tolylene 2,6-diisocyanate.
9. The process as claimed in any of the preceding aspects, characterized in that component D comprises not more than 26.5% by weight of tolylene 2,6-diisocyanate, based on the total weight of component D, preferably with 22.0% to 26.5% by weight comprising tolylene 2,6-diisocyanate, based on the total weight of component D, more preferably with 20.0% to 23.3% by weight comprising tolylene 2,6-diisocyanate, based on the total weight of component D, most preferably with 20.0% by weight comprising tolylene 2,6-diisocyanate, based on the total weight of component D.
10. The process as claimed in aspect 9, characterized in that tolylene 2,4-diisocyanate and tolylene 2,6-diisocyanate are used in the form of a mixture of at least one batch, preferably two batches different from one another, wherein the first batch comprises tolylene 2,4-diisocyanate and tolylene 2,6-diisocyanate in a ratio of 80% by weight to 20% by weight and the second batch comprises tolylene 2,4-diisocyanate and tolylene 2,6-diisocyanate in a ratio of 67% by weight to 33% by weight, wherein the proportion of the second batch is not more than 25% by weight, preferably not more than 10% by weight, based on the total weight of the first and the second batch, more preferably wherein only the two batches are used as component D.
11. A polyurethane foam having a density in accordance with DIN EN ISO 845:2009-10 from 50.0 to 80.0 kg/m³, obtainable by a process as claimed in any of aspects 1 to 10.
12. The polyurethane foam as claimed in aspect 11, characterized in that it is a flexible polyurethane foam, in particular an open-cell flexible polyurethane foam.
13. The polyurethane foam as claimed in aspect 11 or 12, characterized in that the polyurethane foam has a density in accordance with DIN EN ISO 845:2009-10 from 65.0 to 75.0 kg/m³.
14. The use of the polyurethane foam as claimed in any of aspects 11 to 13 for producing furniture cushioning, textile inserts, mattresses, automobile seats, headrests, armrests, sponges, foam films for use in automobile components, for example inner roof linings, door trim, seat covers, and structural components.
15. A two-component system for producing polyurethane foams having a density in accordance with DIN EN ISO 845:2009-10 from 50.0 to 80.0 kg/m³ comprising a first component K1 comprising or consisting of:
   component A) comprising one or more polyether polyols A1, in particular having a hydroxyl value in accordance with DIN 53240-1:2013-06 from 20 mg KOH/g to 250 mg KOH/g, preferably 40 to 60 mg KOH/g, and an ethylene oxide content from 0.10% to 59.0% by weight (component A1), wherein the polyether polyols A1 are preferably free of carbonate units,
   B) optionally
   B1) catalysts, and/or
   B2) auxiliaries and additives,
   C water and/or physical blowing agents, and
   E) a compound that has the formula (I) below:

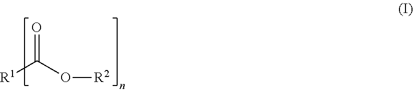

where
R¹ is an aromatic hydrocarbon radical having at least 5 carbon atoms or is a linear, branched, substituted or unsubstituted aliphatic hydrocarbon radical having at least 2 carbon atoms;
R² is a linear, branched, substituted or unsubstituted aliphatic hydrocarbon radical; and
n is 1 to 3,
and a second component K2 comprising or consisting of:
D) di- and/or polyisocyanates that comprise or consist of tolylene 2,4-diisocyanate and tolylene 2,6-diisocyanate,
and at least one catalyst, wherein component K1 and component K2 are present in a ratio of an isocyanate index of 90 to 120, preferably 100 to 115, more preferably 102 to 110.

Where hydroxyl values are disclosed hereinafter as being in accordance with DIN 53240, this is understood as meaning in particular the hydroxyl value in accordance with DIN 53240-1:2013-06.

A further aspect of the invention is a process for producing polyurethane foams, preferably flexible polyurethane foams, through the reaction of

A1 ≥40 to ≤100 parts by weight, preferably ≥60 to ≤100 parts by weight, more preferably ≥80 to ≤100 parts by weight, of one or more polyether polyols having a hydroxyl value in accordance with DIN 53240 from 20 mg KOH/g to ≤250 mg KOH/g, preferably 40 to 60 mg KOH/g, and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight, wherein the polyether polyols A1 are in particular free of carbonate units,
A2 ≤60 to ≥0 parts by weight, preferably ≤40 to ≥0.1 parts by weight, more preferably ≤20 to ≥1 parts by weight, of one or more polyether carbonate polyols having a hydroxyl value in accordance with DIN 53240 from ≥20 mg KOH/g to ≤120 mg KOH/g,
A3 ≤60 to ≥0 parts by weight, preferably 0.1 to 20 parts by weight, based on the sum of the parts by weight of components A1 and A2, of one or more polyether polyols having a hydroxyl value in accordance with DIN 53240 from ≥20 mg KOH/g to ≤250 mg KOH/g and an ethylene oxide content of >60% by weight, wherein the polyether polyols A3 are in particular free of carbonate units,
A4 ≤40 to ≥0 parts by weight, preferably 0.1 to 20 parts by weight, based on the sum of the parts by weight of components A1 and A2, of one or more polymer polyols, PUD polyols, and/or PIPA polyols,
A5 ≤40 to ≥0 parts by weight, preferably 0.1 to 20 parts by weight, based on the sum of the parts by weight of components A1 and A2, of polyols that do not come under the definition of components A1 to A4,
B optionally
B1) catalysts and/or
B2) auxiliaries and additives,
C water and/or physical blowing agents,
with
D di- and/or polyisocyanates,
wherein production is carried out at an index of 90 to 120, preferably 100 to 115, more preferably 102 to 110,
wherein all stated parts by weight of components A1, A2, A3, A4, A5 are normalized so that the sum of the parts by weight of A1+A2 in the composition is 100,
characterized in that production takes place in the presence of component K.

Components A1 to A5 in each case relate to “one or more” of the compounds mentioned. Where a plurality of compounds is used for one component, the stated amount corresponds to the sum of the parts by weight of the compounds.

In a preferred embodiment, component A comprises

A1 ≤95 to ≥65 parts by weight, most preferably ≤90 to ≥85 parts by weight, of one or more polyether polyols having a hydroxyl value in accordance with DIN 53240 from ≥20 mg KOH/g to ≤250 mg KOH/g, preferably 40 to 60 mg KOH/g, and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight, wherein the polyether polyols A1 are in particular free of carbonate units, and
A2 ≥5 to ≤35 parts by weight, most preferably ≥10 to ≤15 parts by weight, of one or more polyether carbonate polyols having a hydroxyl value in accordance with DIN 53240 from ≥20 mg KOH/g to ≤120 mg KOH/g and preferably a CO₂ content from 15% to 25% by weight, wherein component A is preferably free of component A3 and/or A4.

In another embodiment, component A comprises

A1 ≤95 to ≥65 parts by weight, preferably ≤90 to ≥80 parts by weight, of one or more polyether polyols having a hydroxyl value in accordance with DIN 53240 from ≥20 mg KOH/g to ≤250 mg KOH/g, preferably 40 to 60 mg KOH/g, and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight, wherein the polyether polyols A1 are preferably free of carbonate units, and
A2 ≥3 to ≤33 parts by weight, preferably ≥8 to ≤18 parts by weight, of one or more polyether carbonate polyols having a hydroxyl value in accordance with DIN 53240 from ≥20 mg KOH/g to ≤120 mg KOH/g and preferably a CO₂ content from 15% to 25% by weight,
A3 ≤20 to ≥2 parts by weight, preferably ≤10 to ≥2 parts by weight, based on the sum of the parts by weight of components A1 and A2, of one or more polyether polyols having a hydroxyl value in accordance with DIN 53240 from ≥20 mg KOH/g to ≤250 mg KOH/g and an ethylene oxide content of >60% by weight, wherein the polyether polyols A3 are in particular free of carbonate units,
wherein component A is preferably free of component A4.

In a further embodiment, component A comprises

A1 ≤99 to ≥60 parts by weight, preferably ≤95 to ≥75 parts by weight, more preferably ≤90 to ≥85 parts by weight, most preferably ≤35 to ≥25 parts by weight, of one or more polyether polyols having a hydroxyl value in accordance with DIN 53240 from ≥20 mg KOH/g to ≤250 mg KOH/g and an ethylene oxide content from 0.10% to 59.0% by weight, preferably 1% to 30% by weight, more preferably 5% to 15% by weight, and/or a propylene oxide content from 40% to 99.9% by weight, preferably 70% to 99% by weight, more preferably 85% to 95% by weight, wherein the polyether polyols A1 are preferably free of carbonate units, and
A2 ≥0.05 to ≤39.9 parts by weight, preferably ≥4.99 to ≤24.99 parts by weight, more preferably ≥9.99 to ≤14.99 parts by weight, of one or more polyether carbonate polyols having a hydroxyl value in accordance with DIN 53240 from ≥20 mg KOH/g to ≤120 mg KOH/g and preferably a CO₂ content from 15% to 25% by weight,
A4 ≤40 to ≥0.01 parts by weight, preferably ≤20 to ≥0.01 parts by weight, more preferably ≤20 to ≥1 parts by weight, most preferably ≤20 to ≥2 parts by weight, based on the sum of the parts by weight of components A1 and A2, of one or more polymer polyols, PUD polyols, and/or PIPA polyols,
A5 ≤40 to ≥0 parts by weight, preferably ≤20 to ≥0.01 parts by weight, based on the sum of the parts by weight of components A1 and A2, of polyols that do not come under the definition of components A1 to A4, wherein component A is preferably free of component A3. The stated ranges and ranges of preference of components A1, A2, A4, and A5 are here freely combinable with one another.

Component A particularly preferably consists solely of A1.

The components used in the process according to the invention are described in more detail hereinbelow.

### Component A1

Component A1 comprises polyether polyols preferably having a hydroxyl value in accordance with DIN 53240 from ≥20 mg KOH/g to ≤250 mg KOH/g, preferably from ≥20 to ≤112 mg KOH/g, and more preferably from ≥20 mg KOH/g to ≤80 mg KOH/g, wherein in preferred aspects, component A1 is free of carbonate units.

The compounds according to A1 may be prepared by catalytic addition of one or more alkylene oxides to H-functional starter compounds.

The alkylene oxides (epoxides) used may be alkylene oxides having 2 to 24 carbon atoms. Alkylene oxides having from 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats in the form of monoglycerides, diglycerides, and triglycerides, epoxidized fatty acids, C1-C24 esters of epoxidized fatty acids, epichlorohydrin, glycidol, and glycidol derivatives, for example methyl glycidyl ether, ethyl glycidyl ether, 2-ethylhexyl glycidyl ether, allyl glycidyl ether, glycidyl methacrylate, and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides used are preferably ethylene oxide and/or propylene oxide and/or 1,2-butylene oxide. Particular preference is given to using an excess of propylene oxide and/or 1,2-butylene oxide. The alkylene oxides may be introduced into the reaction mixture individually, in a mixture or successively. The copolymers may be random or block copolymers. If the alkylene oxides are metered in successively, the products (polyether polyols) produced contain polyether chains having block structures.

The H-functional starter compounds have functionalities from ≥2 to ≤6 and are preferably hydroxy-functional (OH-functional). Examples of hydroxy-functional starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol-containing condensates of formaldehyde and phenol or melamine or urea. These may also be used as mixtures. The starter compound used is preferably 1,2-propylene glycol and/or glycerol and/or trimethylolpropane and/or sorbitol.

The polyether polyols according to A1 have an ethylene oxide content from ≥0.1% to ≤59.0% by weight, preferably from ≥1% to ≤30% by weight, more preferably ≥5% to ≤15% by weight and/or a propylene oxide content from 40% to 99.9% by weight, preferably 70% to 99% by weight, more preferably 85% to 95% by weight. The propylene oxide units are particularly preferably terminal.

### Component A2

Component A2 comprises a polyether carbonate polyol in which the hydroxyl value (OH value) in accordance with DIN 53240-1:2013-06 is preferably from ≥20 mg KOH/g to ≤120 mg KOH/g, preferably from ≥20 mg KOH/g to ≤100 mg KOH/g, more preferably from ≥25 mg KOH/g to ≤90 mg KOH/g, that can be obtained by copolymerization of carbon dioxide and one or more alkylene oxides in the presence of one or more H-functional starter molecules, wherein the polyether carbonate polyol preferably has a CO₂ content from 15% to 25% by weight. Component A2 preferably comprises a polyether carbonate polyol that is obtainable by copolymerization of from ≥2% by weight to ≤30% by weight of carbon dioxide and from ≥70% by weight to ≤98% by weight of one or more alkylene oxides in the presence of one or more H-functional starter molecules having an average functionality from ≥1 to ≤6, preferably from ≥1 to ≤4, more preferably from ≥2 to ≤3. For the purposes of the invention, the expression “H-functional” refers to a starter compound having H atoms that are active in respect of alkoxylation.

The copolymerization of carbon dioxide and one or more alkylene oxides is preferably carried out in the presence of at least one DMC catalyst (double metal cyanide catalyst).

The polyether carbonate polyols used according to the invention preferably also contain ether groups between the carbonate groups, as shown schematically in formula (II). In the scheme according to formula (II), R is an organic radical such as alkyl, alkylaryl or aryl that may in each case also contain heteroatoms such as O, S, Si, etc. and e and f are each an integer. The polyether carbonate polyol shown in the scheme according to formula (II) should be understood as meaning merely that blocks containing the depicted structure may in principle be present in the polyether carbonate polyol; the order, number and length of the blocks may, however, vary and are not restricted to the polyether carbonate polyol shown in formula (II). In relation to formula (II), this means that the ratio of e/f is preferably from 2:1 to 1:20, more preferably from 1.5:1 to 1:10.

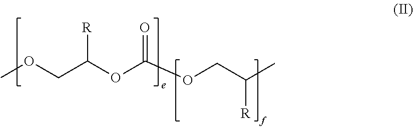

The proportion of incorporated CO₂ (“units derived from carbon dioxide”; “CO₂ content”) in a polyether carbonate polyol can be determined from the evaluation of characteristic signals in the NMR spectrum. The example below illustrates the determination of the proportion of units derived from carbon dioxide in a CO₂/propylene oxide polyether carbonate polyol with 1,8-octanediol as starter molecule.

The proportion of incorporated CO₂ in a polyether carbonate polyol and the ratio of propylene carbonate to polyether carbonate polyol can be determined by ¹H NMR (a suitable instrument is from Bruker, DPX 400, 400 MHz; zg30 pulse program, delay time dl: 10 s, 64 scans). Each sample is dissolved in deuterated chloroform. The relevant resonances in the ¹H NMR (based on TMS=0 ppm) are as follows:

Cyclic propylene carbonate (that was formed as a by-product) with a resonance at 4.5 ppm; carbonate resulting from carbon dioxide incorporated in the polyether carbonate polyol with resonances at 5.1 to 4.8 ppm; unreacted propylene oxide (PO) with a resonance at 2.4 ppm; polyether polyol (i.e. without incorporated carbon dioxide) with resonances at 1.2 to 1.0 ppm; the octane-1,8-diol incorporated as starter molecule (if present) with a resonance at 1.6 to 1.52 ppm.

The proportion by weight (in % by weight) of polymer-bound carbonate (LC) in the reaction mixture was calculated by formula (III)

$${LC}^{′} = \frac{[ A ( 5.1 - 4.8 ) - A ( 4.5 ) ] * 102}{D} * 100 \% \qquad ( III )$$

where the value of D (“denominator” D) is calculated by formula (IV):

D=[A(5.1−4.8)−A(4.5)]*102+A(4.5)*102+A(2.4)*58+0.33*A(1.2−1.0)*58+0.25*A(1.6−1.52)*146 (IV)

The following abbreviations are used here:

A(4.5)=Area of the resonance at 4.5 ppm for cyclic carbonate (corresponds to one H atom)
A(5.1−4.8)=Area of the resonance at 5.1−4.8 ppm for polyethercarbonate polyol and one hydrogen atom for cyclic carbonate
A(2.4)=Area of the resonance at 2.4 ppm for free, unreacted PO
A(1.2−1.0)=Area of the resonance at 1.2−1.0 ppm for polyether polyol
A(1.6−1.52)=Area of the resonance at 1.6 to 1.52 ppm for octane-1,8-diol (starter), if present.

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The proportion by weight (in % by weight) of cyclic carbonate (CC) in the reaction mixture was calculated by formula (V):

$${CC}^{′} = \frac{A ( 4.5 ) * 102}{D} * 100 \% \qquad ( V )$$

where the value of D is calculated by formula (IV).

In order to calculate the composition based on the polymer component (consisting of polyether polyol formed from starter and propylene oxide during the activation steps that take place in the absence of CO₂ and polyether carbonate polyol formed from starter, propylene oxide, and carbon dioxide during the activation steps that take place in the presence of CO₂ and during the copolymerization) from the values for the composition of the reaction mixture, the non-polymeric constituents of the reaction mixture (i.e. cyclic propylene carbonate and any unreacted propylene oxide present) were mathematically eliminated. The proportion by weight of repeat carbonate units in the polyether carbonate polyol was converted to a proportion by weight of carbon dioxide by application of the factor F=44/(44+58). The stated CO₂ content in the polyether carbonate polyol is normalized relative to the proportion of the polyether carbonate polyol molecule that was formed in the copolymerization and in any activation steps in the presence of CO₂ (i.e. the proportion of the polyether carbonate polyol molecule resulting from the starter (1,8-octanediol, if present) and from the reaction of the starter with epoxide that was added in the absence of CO₂ was disregarded here).

For example, the preparation of polyether carbonate polyols as per A2) comprises:

(α) initially charging an H-functional starter compound or a mixture of at least two H-functional starter compounds and optionally removing water and/or other volatile compounds by means of elevated temperature and/or reduced pressure (“drying”), wherein the DMC catalyst is added to the H-functional starter compound or to the mixture of at least two H-functional starter compounds before or after drying,
(β) adding a partial amount (based on the total amount of the amount of alkylene oxides used in the activation and copolymerization) of one or more alkylene oxides to the mixture resulting from step (α) to effect activation, wherein this addition of a partial amount of alkylene oxide may optionally be carried out in the presence of CO₂, and wherein there is then a wait in each case for the hot spots that arise as a result of the ensuing exothermic chemical reaction and/or for a decrease in the pressure in the reactor, and wherein the activation step (β) may also be carried out multiple times,
(γ) adding one or more alkylene oxides and carbon dioxide to the mixture resulting from step (β), wherein the alkylene oxides used in step (β) may be the same as or different than the alkylene oxides used in step (γ),

In general, alkylene oxides (epoxides) having 2 to 24 carbon atoms may be used for preparing the polyether carbonate polyols A2. The alkylene oxides having from 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats in the form of monoglycerides, diglycerides, and triglycerides, epoxidized fatty acids, C1-C24 esters of epoxidized fatty acids, epichlorohydrin, glycidol, and glycidol derivatives, for example methyl glycidyl ether, ethyl glycidyl ether, 2-ethylhexyl glycidyl ether, allyl glycidyl ether, glycidyl methacrylate, and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides used are preferably ethylene oxide and/or propylene oxide and/or 1,2-butylene oxide, more preferably propylene oxide.

In a preferred embodiment of the invention, the proportion of ethylene oxide in the total amount of propylene oxide and ethylene oxide used is from ≥0% to ≤90% by weight, preferably from ≥0% to ≤50% by weight, and is more preferably free of ethylene oxide.

Compounds having hydrogen atoms that are active in respect of alkoxylation may be used as suitable H-functional starter substances. Groups active in respect of alkoxylation and having active hydrogen atoms are for example —OH, —NH₂ (primary amines), —NH— (secondary amines), —SH and

—CO₂H, preferably —OH and —NH₂, more preferably —OH. The H-functional starter compound used is for example one or more compounds selected from the group consisting of water, mono- or polyhydric alcohols, polyamines, polythiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines (for example so-called Jeffamines® from Huntsman, for example D-230, D-400, D-2000, T-403, T-3000, T-5000 or corresponding BASF products, for example Polyetheramine D230, D400, D200, T403, T5000), polytetrahydrofurans (for example PolyTHF® from BASF, for example PolyTHF® 250, 650S, 1000, 1000S, 1400, 1800, 2000), polytetrahydrofuranamines (BASF product Polytetrahydrofuranamine 1700), polyether thiols, polyacrylate polyols, castor oil, ricinoleic acid mono- or diglycerides, monoglycerides of fatty acids, chemically modified mono-, di- and/or triglycerides of fatty acids, and C1-C24-alkyl fatty acid esters containing an average of at least 2 OH groups per molecule. Examples of C1-C24 alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol® products (from USSC Co.).

Monofunctional starter compounds used may be alcohols, amines, thiols, and carboxylic acids. Monofunctional alcohols used may be: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Monofunctional amines that may be considered include: butylamine, t-butylamine, pentylamine, hexylamine, aniline, aziridine, pyrrolidine, piperidine, morpholine. As monofunctional thiols, it is possible to use: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter compounds are dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these abovementioned alcohols containing different amounts of ε-caprolactone. In mixtures of H-functional starters, it is also possible to use trihydric alcohols, for example trimethylolpropane, glycerol, trishydroxyethyl isocyanurate, and castor oil.

The H-functional starter compounds may also be selected from the substance class of polyether polyols, in particular those having a molecular weight Mn in the range from 100 to 4000 g/mol, preferably from 250 to 2000 g/mol. Preference is given to polyether polyols formed from repeat ethylene oxide and propylene oxide units, preferably having a proportion of propylene oxide units from 35 to 100%, more preferably having a proportion of propylene oxide units from 50 to 100%. These may be random copolymers, gradient copolymers, alternating copolymers or block copolymers of ethylene oxide and propylene oxide. Examples of suitable polyether polyols formed from repeat propylene oxide and/or ethylene oxide units are the Desmophen®, Acclaim®, Arcol®, Baycoll®, Bayfill®, Bayflex® Baygal®, PET®, and polyether polyols from Covestro Deutschland AG (for example Desmophen® 3600Z, Desmophen® 1900U, Acclaim® Polyol 2200, Acclaim® Polyol 4000I, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Desmophen® 50RE40). Examples of further suitable homopolyethylene oxides are the Pluriol® E brands from BASF SE, examples of suitable homopolypropylene oxides are the Pluriol® P brands from BASF SE, examples of suitable mixed copolymers of ethylene oxide and propylene oxide are the Pluronic® PE or Pluriol® RPE brands from BASF SE.

The H-functional starter compounds may also be selected from the substance class of polyester polyols, in particular those having a molecular weight Mn in the range from 200 to 4500 g/mol, preferably 400 to 2500 g/mol. The polyester polyols used are at least difunctional polyesters. Polyester polyols preferably consist of alternating acid and alcohol units. Examples of acid components used are succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Examples of alcohol components used are ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Using dihydric or polyhydric polyether polyols as alcohol components gives polyester ether polyols that can likewise serve as starter compounds for preparing the polyether carbonate polyols. If polyether polyols are used to prepare the polyester ether polyols, preference is given to polyether polyols having a number-average molecular weight Mn of 150 to 2000 g/mol.

In addition, the H-functional starter compounds used may be polycarbonate polyols (for example polycarbonate diols), especially those having a molecular weight Mn in the range from 150 to 4500 g/mol, preferably 500 to 2500, which are prepared for example through the reaction of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. For example, the polycarbonate diols may be the Desmophen® C grades from Covestro Deutschland AG, for example Desmophen® C 1100 or Desmophen® C 2200.

It is likewise possible to use polyether carbonate polyols as H-functional starter compounds. Polyether carbonate polyols prepared by the method described above are used in particular. These polyether carbonate polyols used as H-functional starter compounds are pre-prepared for this purpose in a separate reaction step.

Preferred H-functional starter compounds are alcohols of the general formula (VI)

HO—(CH₂)ₓ—OH (VI)

where x is a number from 1 to 20, preferably an even number from 2 to 20. Examples of alcohols of formula (VI) are ethylene glycol, butane-1,4-diol, hexane-1,6-diol, octane-1,8-diol, decane-1,10-diol, and dodecane-1,12-diol. Further preferred H-functional starter compounds are neopentyl glycol, trimethylolpropane, glycerol, pentaerythritol, reaction products of the alcohols of formula (II) with ε-caprolactone, for example reaction products of trimethylolpropane with ε-caprolactone, reaction products of glycerol with ε-caprolactone, and reaction products of pentaerythritol with ε-caprolactone. Preference is further given to using, as H-functional starter compounds, water, diethylene glycol, dipropylene glycol, castor oil, sorbitol, and polyether polyols formed from repeat polyalkylene oxide units.

The H-functional starter compounds are particularly preferably one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, difunctional and trifunctional polyether polyols, where the polyether polyol is formed from a di- or tri-H-functional starter substance and propylene oxide or a di- or tri-H-functional starter substance, propylene oxide, and ethylene oxide. The polyether polyols preferably have a number-average molecular weight Mn in the range from 62 to 4500 g/mol and especially a number-average molecular weight Mn in the range from 62 to 3000 g/mol, most preferably a molecular weight from 62 to 1500 g/mol. The polyether polyols preferably have a functionality from ≥2 to ≤3.

In a preferred embodiment of the invention, the polyether carbonate polyol A2 is obtainable by addition of carbon dioxide and alkylene oxides to H-functional starter compounds using multimetal cyanide catalysts (DMC catalysts). The preparation of polyether carbonate polyols by addition of alkylene oxides and CO₂ to H-functional starter compounds using DMC catalysts is known, for example, from EP-A 0222453, WO-A 2008/013731 and EP-A 2115032.

DMC catalysts are known in principle from the prior art for homopolymerization of epoxides (see, for example, U.S. Pat. Nos. 3,404,109, 3,829,505, 3,941,849, and 5,158,922). DMC catalysts described, for example, in U.S. Pat. No. 5,470,813, EP-A 700 949, EP-A 743 093, EP-A 761 708, WO-A 97/40086, WO-A 98/16310, and WO-A 00/47649 have very high activity in the homopolymerization of epoxides and make it possible to prepare polyether polyols and/or polyether carbonate polyols at very low catalyst concentrations (25 ppm or less). A typical example is the highly active DMC catalysts described in EP-A 700 949, which comprise not only a double metal cyanide compound (for example zinc hexacyanocobaltate(III)) and an organic complex ligand (for example tert-butanol) but also a polyether having a number-average molecular weight Mn greater than 500 g/mol.

The DMC catalyst is usually used in an amount of ≤1% by weight, preferably in an amount of ≤0.5% by weight, more preferably in an amount of ≤500 ppm and especially in an amount of ≤300 ppm, in each case based on the weight of the polyether carbonate polyol.

In a preferred embodiment of the invention, the polyether carbonate polyol A2 has a content of carbonate groups (“units derived from carbon dioxide”), calculated as CO₂, from ≥2.0 to ≤30.0% by weight, preferably from ≥5.0 to ≤28.0% by weight, and more preferably from ≥10.0 to ≤25.0% by weight.

In a further embodiment of the process according to the invention, the polyether carbonate polyol(s) A2 have a hydroxyl value from ≥20 mg KOH/g to ≤250 mg KOH/g and are obtainable by copolymerization of from ≥2.0% by weight to ≤30.0% by weight of carbon dioxide and from ≥70% by weight to ≤98% by weight of propylene oxide in the presence of a hydroxy-functional starter molecule, for example trimethylolpropane and/or glycerol and/or propylene glycol and/or sorbitol. The hydroxyl value can be determined in accordance with DIN 53240.

A further embodiment uses a polyether carbonate polyol A2 containing blocks of formula (II), where the ratio e/f is from 2:1 to 1:20.

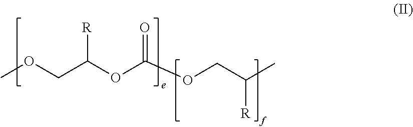

### Component A3

Component A3 comprises polyether polyols having a hydroxyl value in accordance with DIN 53240 from ≥20 mg KOH/g to ≤250 mg KOH/g, preferably from ≥20 to ≤112 mg KOH/g, and more preferably ≥20 mg KOH/g to ≤80 mg KOH/g.

Component A3 is in principle prepared in an analogous manner to component A1, but with a content of ethylene oxide in the polyether polyol being set at >60% by weight, preferably >65% by weight.

Possible alkylene oxides and H-functional starter compounds are the same as those described for component A1.

However, preference is given to H-functional starter compounds having a functionality from ≥3 to ≤6, more preferably of 3, so that polyether triols are formed. Preferred starter compounds having a functionality of 3 are glycerol and/or trimethylolpropane, more preferably glycerol.

In a preferred embodiment, component A3 is a glycerol-started trifunctional polyether having an ethylene oxide content from 68% to 73% by weight and an OH value from 35 to 40 mg KOH/g.

### Component A4

Component A4 comprises polymer polyols, PUD polyols, and PIPA polyols. Polymer polyols are polyols that contain proportions of solid polymers produced by free-radical polymerization of suitable monomers such as styrene or acrylonitrile in a base polyol, for example a polyether polyol and/or polyether carbonate polyol.

PUD (polyurea dispersion) polyols are, for example, prepared by in-situ polymerization of an isocyanate or an isocyanate mixture with a diamine and/or hydrazine in a polyol, preferably a polyether polyol. The PUD dispersion is preferably prepared through the reaction of an isocyanate mixture used from a mixture consisting of 75% to 85% by weight of tolylene 2,4-diisocyanate (2,4-TDI) and 15% to 25% by weight of tolylene 2,6-diisocyanate (2,6-TDI) with a diamine and/or hydrazine in a polyether polyol, preferably a polyether polyol and/or polyether carbonate polyol prepared by alkoxylation of a trifunctional starter (for example glycerol and/or trimethylolpropane) in the presence of carbon dioxide in the case of the polyether carbonate polyol. Methods for preparing PUD dispersions are described, for example, in U.S. Pat. Nos. 4,089,835 and 4,260,530.

PIPA polyols are polyether polyols and/or polyether carbonate polyols modified with alkanolamines, preferably modified with triethanolamine, by polyisocyanate polyaddition, where the polyether (carbonate) polyol has a functionality from 2.5 to 4 and a hydroxyl value from ≥3 mg KOH/g to ≤112 mg KOH/g (molecular weight from 500 to 18 000). The polyether polyol is preferably “EO capped”, i.e. the polyether polyol has terminal ethylene oxide groups. PIPA polyols are described in detail in GB 2 072 204 A, DE 31 03 757 A1 and U.S. Pat. No. 4,374,209 A.

### Component A5

It is possible to use as component A5 all polyhydroxy compounds known to those skilled in the art that do not come under the definition of components A1 to A4, and preferably have an average OH functionality of >1.5.

These may, for example, be low-molecular-weight diols (for example ethane-1,2-diol, propane-1,3-diol, propane-1,2-diol, butane-1,4-diol), triols (for example glycerol, trimethylolpropane), and tetraols (for example pentaerythritol), polyester polyols, polythioether polyols or polyacrylate polyols, and also polyether polyols or polycarbonate polyols that do not come under the definition of components A1 to A4. It is also possible to use, for example, ethylenediamine- and triethanolamine-started polyethers. These compounds are not counted as compounds according to the definition of component B2.

### Component B

As catalysts in accordance with component B1, preference is given to using

a) aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethyl(bisaminoethyl ether)), cycloaliphatic amino ethers (for example N-ethylmorpholine), aliphatic amidines, cycloaliphatic amidines, urea and urea derivatives (for example aminoalkylureas, see for example EP-A 0 176 013, in particular (3-dimethylaminopropylamino)urea) and/or
b) tin(II) salts of carboxylic acids.

In particular, the tin(II) salts of carboxylic acids are used, wherein the parent carboxylic acid in each case has from 2 to 24 carbon atoms. The tin(II) salts of carboxylic acids used are, for example, one or more compounds selected from the group consisting of the tin(II) salt of 2-ethylhexanoic acid (i.e. tin(II) 2-ethylhexanoate or tin octoate), the tin(II) salt of 2-butyloctanoic acid, the tin(II) salt of 2-hexyldecanoic acid, the tin(II) salt of neodecanoic acid, the tin(II) salt of isononanoic acid, the tin(II) salt of oleic acid, the tin(II) salt of ricinoleic acid, and tin(II) laurate.

A preferred embodiment of the invention uses at least one tin(II) salt of the formula (VII)

Sn(CxH₂ₓ₊₁COO)₂ (VII)

where x is an integer from 8 to 24, preferably from 10 to 20, more preferably from 12 to 18. In formula (IX), the alkyl chain CₓH₂ₓ₊₁ of the carboxylate is particularly preferably a branched carbon chain, i.e. CₓH₂ₓ₊₁ is an isoalkyl group.

Most preferably, the tin(II) salts of carboxylic acids used are one or more compounds selected from the group consisting of the tin(II) salt of 2-butyloctanoic acid, i.e. tin(II) 2-butyloctoate, the tin(II) salt of ricinoleic acid, i.e. tin(II) ricinoleate, and the tin(II) salt of 2-hexyldecanoic acid, i.e. tin(II) 2-hexyldecanoate.

In another preferred embodiment of the invention, the component B1 used consists of

B1.1 ≥0.05 to ≤1.5 parts by weight, based on the sum of the parts by weight of components A1 and A2, of urea, and/or urea derivatives and
B1.2 ≥0.03 to ≤1.5 parts by weight, based on the sum of the parts by weight of components A1 and A2, of catalysts other than those of the component B1.2, wherein the content of amine catalysts in component B1.2 is not more than 50% by weight based on component B1.

Component B1.1 comprises urea and urea derivatives. Examples of urea derivatives are: aminoalkylureas, for example (3-dimethylaminopropylamine)urea and 1,3-bis[3-(dimethylamino)propyl]urea. It is also possible to use mixtures of urea and urea derivatives. Preference is given to using exclusively urea in component B1.1. Component B1.1 is used in amounts from ≥0.05 to ≤1.5 parts by weight, preferably from ≥0.1 to ≤0.5 parts by weight, more preferably from ≥0.25 to ≤0.35 parts by weight, based on the sum of the parts by weight of components A1 to A2.

Component B1.2 is used in amounts from ≥0.03 to ≤1.5 parts by weight, preferably ≥0.03 to ≤0.5 parts by weight, more preferably from ≥0.1 to ≤0.3 parts by weight, most preferably from ≥0.2 to ≤0.3 parts by weight, based on the sum of the parts by weight of components A1 to A2.

The content of amine catalysts in component B1.2 is preferably not more than 50% by weight based on component B1.1, more preferably not more than 25% by weight based on component B1.1. Component B1.2 is very particularly preferably free of amine catalysts. The catalysts used for component B1.2 may for example be the tin(II) salts of carboxylic acids described above.

Amine catalysts that may optionally be additionally used in small amounts (see above) include: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bisdimethylaminoethyl ether, 2-(2-dimethylaminoethoxy)ethanol and N,N,N-trimethyl-N-hydroxyethyl(bisaminoethyl ether)), cycloaliphatic amino ethers (for example N-ethylmorpholine), aliphatic amidines, and cycloaliphatic amidines

The “amine catalysts” specified in B1.2 do not include urea or derivatives thereof.

A nonalkaline medium can preferably be achieved by using urea and/or urea derivatives as catalysts in accordance with component B1 and not using any amine catalysts.

As component B2, it is possible to use auxiliaries and additives such as

a) surface-active additives such as emulsifiers and foam stabilizers, in particular those having low emissions, for example products of the Tegostab® series,
b) additives such as reaction retarders (for example acidic substances such as hydrochloric acid or organic acid halides), cell regulators (for example paraffins or fatty alcohols or dimethylpolysiloxanes), pigments, dyes, flame retardants (different from component K3; for example ammonium polyphosphate), further stabilizers against aging and weathering effects, antioxidants, plasticizers, fungistatic and bacteriostatic substances, fillers (for example barium sulfate, kieselguhr, black chalk or prepared chalk) and release agents.

These auxiliaries and additives for optional additional use are described, for example, in EP-A 0 000 389, pages 18-21. Further examples of auxiliaries and additives that may optionally be additionally used according to the invention and details on the use and mode of action of these auxiliaries and additives are described in Kunststoff-Handbuch [Plastics Handbook], volume VII, edited by G. Oertel, Carl-Hanser-Verlag, Munich, 3rd edition, 1993, for example on pages 104-127.

### Component C

Water and/or physical blowing agents are used as component C. Examples of physical blowing agents used as blowing agents are carbon dioxide and/or volatile organic substances. Preference is given to using water as component C.

### Component D

The di- and/or polyisocyanates of the present invention comprise or consist of tolylene 2,4-diisocyanate and tolylene 2,6-diisocyanate. These are, for example, polyisocyanates such as those described in EP-A 0 007 502, pages 7-8. Preference is generally given to readily industrially obtainable polyisocyanates, for example tolylene 2,4- and 2,6-diisocyanate, and any desired mixtures thereof with isomers (“TDI”); polyphenylpolymethylene polyisocyanates prepared by aniline-formaldehyde condensation and subsequent phosgenation (“crude MDI”), and polyisocyanates bearing carbodiimide groups, urethane groups, allophanate groups, isocyanurate groups, urea groups or biuret groups (“modified polyisocyanates”), especially modified polyisocyanates derived from tolylene 2,4- and/or 2,6-diisocyanate or from diphenylmethane 4,4′- and/or 2,4′-diisocyanate. Preference is given to using a mixture of tolylene 2,4- and 2,6-diisocyanate with diphenylmethane 4,4′- and/or 2,4′- and/or 2,2′-diisocyanate and polyphenylpolymethylene polyisocyanate (“multiring MDI”). Particular preference is given to using tolylene 2,4- and/or 2,6-diisocyanate.

In a further embodiment of the process according to the invention, the isocyanate component D consists 100% of tolylene 2,4-diisocyanate.

According to the invention, the index for the process according to the invention is ≥90 to ≤120. The index is preferably within a range from ≥100 to ≤115, more preferably from ≥102 to ≤110. The index indicates the percentage ratio of the amount of isocyanate actually used to the stoichiometric amount of isocyanate (NCO) groups, i.e. the calculated amount for conversion of the OH equivalents:

Index=(amount of isocyanate used):(amount of isocyanate calculated)·100 (VIII)

In a preferred aspect, the components are used as follows:

Component A1 in 70% to 100% by weight, in particular 90% by weight or 100% by weight; and/or

Component A2 or A3 in 0% to 30% by weight, in particular 10% by weight or 0% by weight, wherein the sum of components A1 and A2 or A3 is 100% by weight; and/or
Component B1 in 0.02% to 0.8% by weight, preferably 0.06% to 0.25% by weight, more preferably 0.22% by weight, based on 100% by weight of A1; and/or
Component B2 in 0.1% to 6% by weight, preferably 0.2% to 1.2% by weight, more preferably 1.3% by weight, based on 100% by weight of A1; and/or
Component C in 0.8% to 3.0% by weight, preferably 1.9% by weight, based on 100% by weight of A1; and/or
Component E in 2.0% to 12% by weight, preferably 2.0% to 8.0% by weight, based on 100% by weight of A1.

For production of the polyurethane foams, the reaction components are preferably reacted according to the one-stage process known per se, often using mechanical equipment, for example that described in EP-A 355 000. Details of processing equipment that may also be considered according to the invention are described in Kunststoff-Handbuch [Plastics Handbook], volume VII, edited by Vieweg and Höchtlen, Carl-Hanser-Verlag, Munich 1993, for example on pages 139 to 265.

The polyurethane foams are preferably in the form of flexible polyurethane foams and may be produced as molded foams or else as slabstock foams, preferably as molded foams. The invention accordingly provides a process for producing the polyurethane foams, the polyurethane foams produced by these processes, the flexible slabstock polyurethane foams/flexible molded polyurethane foams produced by these processes, the use of the flexible polyurethane foams for the production of moldings, and the moldings themselves.

The polyurethane foams, preferably flexible polyurethane foams, obtainable according to the invention are used for example in: furniture cushioning, textile inserts, mattresses, automobile seats, headrests, armrests, sponges, foam films for use in automobile components, for example inner roof linings, door trim, seat covers, and structural components.

### EXAMPLES

### Component A:

A1-1 Arcol Polyol 1108: Propylene oxide/ethylene oxide-based polyol; prepared by DMC catalysis; starter: glycerol; OH value: 48 mg KOH/g

### Component B:

B1-1 Bis[(2-dimethylamino)ethyl]ether (70% by weight) in dipropylene glycol (30% by weight) (Niax® catalyst A-1, Momentive Performance Chemicals, Leverkusen, Germany).
B1-2 1,4-Diazabicyclo[2.2.2]octane (33% by weight) in dipropylene glycol (67% by weight) (Dabco® 33 LV, Evonik, Essen, Germany).
B1-3 Tin(II) 2-ethylhexanoate (Dabco T-9, commercially available from Evonik, Essen, Germany)
B2-1 Polyether siloxane-based foam stabilizer Tegostab B 8002 (Evonik, Essen, Germany)
B2-2 Polyether siloxane-based foam stabilizer Tegostab® B 8244 (Evonik, Essen, Germany)

### Component C: Water

### Component D:

D-1: Mixture of 2,4- and 2,6-TDI in a weight ratio of 80:20 and having an NCO content of 48% to 48.2% by weight, commercially available as Desmodur T 80 (Covestro AG).
D-2: Mixture of 2,4- and 2,6-TDI in a weight ratio of 67:33 and having an NCO content of 48% to 48.2% by weight, commercially available as Desmodur T 65 (Covestro AG).

### Component E:

E-1: Diisodecyl sebacate, commercially available as Uniplex DIDS
E-2: Tris(2-ethylhexyl) O-acetylcitrate, commercially available as Citrofol AHII
E-3: Bis(2-ethylhexyl) adipate, commercially available as Oxsoft DOA
E-4: Acetyl tributyl citrate, commercially available as Citrofol BII
E-5: Tris(2-ethylhexyl) trimellitate, also known as trioctyl mellitate
E-6: Trioctyldodecyl citrate, commercially available as Siltech CE-2000 from Siltech Corporation
E-7: Hexyl hexanoate

### Production of the Polyurethane Foams

The starting components are processed in a single-stage process by slabstock foaming under the processing conditions customary for the production of polyurethane foams.

The density was determined in accordance with DIN EN ISO 845:2009-10.

The compression hardness (CLD 40%) was determined in accordance with DIN EN ISO 845:2009-10 at a deformation of 40%, 1st and 4th cycle.

Tensile strength and elongation at break were determined in accordance with DIN EN ISO 1798:2008-04.

The compression set (CS 90%) was determined in accordance with DIN EN ISO 1856:2008-01 at 90% compression.

The compression set (CS 50%) was determined in accordance with DIN EN ISO 1856:2008-01 (22 h, 70° C.) at 50% compression.

In the table below, comparative examples are indicated as CE and examples according to the invention as IE.

TABLE 1
CE 1 and IE 1 to 5, table continued on next page,
IE 6 to 10, pphp = parts per 100 parts polyol;

| | | CE 1 | IE 1 | IE 2 | IE 3 | IE 4 | IE 5 |
|---|---|---|---|---|---|---|---|
| Arcol Polyol 1108 | pphp | 100 | 100 | 100 | 100 | 100 | 100 |
| Water (added) | pphp | 1.20 | 1.20 | 1.20 | 1.20 | 1.20 | 1.20 |
| Tegostab B 8002 | pphp | 0 | 0.80 | 0.80 | 0.80 | 0.80 | 0.80 |
| Tegostab B 8244 | pphp | 0.80 | 0 | 0 | 0 | 0 | 0 |
| Oxsoft DOA | pphp | 0 | 8 | 8 | 0 | 0 | 0 |
| Uniplex DIDS | pphp | 0 | 0 | 0 | 8 | 0 | 0 |
| Citrofol AHII | pphp | 0 | 0 | 0 | 0 | 8 | 0 |
| Citrofol BII | pphp | 0 | 0 | 0 | 0 | 0 | 8 |
| Trioctyl mellitate | pphp | 0 | 0 | 0 | 0 | 0 | 0 |
| Siltech CE-2000 | pphp | 0 | 0 | 0 | 0 | 0 | 0 |
| Hexyl hexanoate | pphp | 0 | 0 | 0 | 0 | 0 | 0 |
| Dabco 33 LV | pphp | 0.22 | 0.20 | 0.20 | 0.20 | 0.20 | 0.20 |
| Niax A-1 | pphp | 0.10 | 0.15 | 0.15 | 0.15 | 0.15 | 0.15 |
| Dabco T-9 (tin octoate) | pphp | 0.20 | 0.17 | 0.17 | 0.17 | 0.17 | 0.17 |
| Desmodur T 80 | pphp | 0 | 10.45 | 15.68 | 10.45 | 10.45 | 10.45 |
| Desmodur T 65 | pphp | 20.79 | 10.45 | 5.23 | 10.45 | 10.45 | 10.45 |
| Water, total | pphp | 1.20 | 1.20 | 1.20 | 1.20 | 1.20 | 1.20 |
| INDEX | [—] | 108 | 108 | 108 | 108 | 108 | 108 |
| Mechanical properties | | | | | | | |
| Density | [kg/m³] | 69.8 | 74.3 | 69.2 | 77.2 | 73.7 | 74.0 |
| Compression hardness 40%; | [kPa] | 7.6 | 7.05 | 7.92 | 8.91 | 8.82 | 8.26 |
| 1st compression | | | | | | | |
| Compression hardness 40%; | [kPa] | 5.79 | 5.61 | 5.58 | 6.93 | 6.53 | 6.27 |
| 4th compression | | | | | | | |
| Compression set 50% | [%] | 1.3 | 1.7 | 2.0 | 1.1 | 1.2 | 1.3 |
| Compression set 90% | [%] | 2.5 | 2.4 | 3.2 | 2.0 | 2.1 | 2.3 |
| Tensile strength | [kPa] | 67 | 50 | 47 | 62 | 51 | 55 |
| Elongation at break | [%] | 137 | 89 | 104 | 86 | 91 | 98 |

| | | IE 6 | IE 7 | IE 8 | IE 9 | IE 10 |
|---|---|---|---|---|---|---|
| Arcol Polyol 1108 | pphp | 100 | 100 | 100 | 100 | 100 |
| Water (added) | pphp | 1.20 | 1.20 | 1.20 | 1.20 | 1.40 |
| Tegostab B 8002 | pphp | 0.80 | 0.80 | 0.80 | 0.80 | 0.80 |
| Oxsoft DOA | pphp | 0 | 0 | 0 | 0 | 0 |
| Uniplex DIDS | pphp | 0 | 0 | 0 | 0 | 0 |
| Citrofol AHII | pphp | 0 | 0 | 0 | 0 | 0 |
| Citrofol BII | pphp | 0 | 0 | 0 | 0 | 0 |
| Trioctyl mellitate | pphp | 8 | 0 | 0 | 0 | 0 |
| Siltech CE-2000 | pphp | 0 | 8 | 0 | 0 | 0 |
| Hexyl hexanoate | pphp | 0 | 0 | 8 | 8 | 8 |
| Dabco 33 LV | pphp | 0.20 | 0.20 | 0.20 | 0.20 | 0.20 |
| Niax A-1 | pphp | 0.15 | 0.15 | 0.15 | 0.15 | 0.15 |
| Dabco T-9 (tin octoate) | pphp | 0.17 | 0.17 | 0.17 | 0.17 | 0.17 |
| Desmodur T 80 | pphp | 10.45 | 10.45 | 10.45 | 15.68 | 22.97 |
| Desmodur T 65 | pphp | 10.45 | 10.45 | 10.45 | 5.23 | 0 |
| | pphp | | | | | |
| Water, total | pphp | 1.20 | 1.20 | 1.20 | 1.20 | 1.40 |
| INDEX | [—] | 108 | 108 | 108 | 108 | 108 |
| Mechanical properties | | | | | | |
| Density | [kg/m³] | 71.8 | 72.2 | 74.9 | 74.3 | 64.4 |
| Compression hardness 40%; | [kPa] | 8.82 | 7.06 | 7.39 | 7.21 | 6.29 |
| 1st compression | | | | | | |
| Compression hardness 40%; | [kPa] | 6.33 | 4.94 | 5.77 | 5.63 | 4.91 |
| 4th compression | | | | | | |
| Compression set 50% | [%] | 1.4 | 2.4 | 2.4 | 2.6 | 2.9 |
| Compression set 90% | [%] | 2.2 | 4.8 | 1.7 | 2.5 | 3.2 |
| Tensile strength | [kPa] | 57 | 56 | 55 | 57 | 53 |
| Elongation at break | [%] | 96 | 124 | 104 | 100 | 107 |

1. A process for producing polyurethane foams having a density in accordance with DIN EN ISO 845:2009-10 from 50.0 to 80.0 kg/m³, comprising reacting
component A) comprising one or more polyether polyols A1,
B) optionally
B1) catalysts, and/or
B2) auxiliaries and additives,
C) water and/or physical blowing agents,
with
D) di- and/or polyisocyanates that comprise tolylene 2,4-diisocyanate and tolylene 2,6-diisocyanate,
wherein production is carried out at an index of 90 to 120,
wherein production takes place in the presence of at least one compound E that has the formula (I) below: 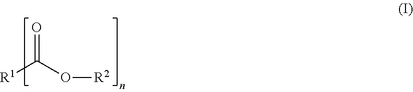
where
R¹ is an aromatic hydrocarbon radical having at least 5 carbon atoms or is a linear, branched, substituted or unsubstituted aliphatic hydrocarbon radical having at least 2 or, if branched, at least 3 carbon atoms;
R² is a linear, branched, substituted or unsubstituted aliphatic hydrocarbon radical; and
n is 1 to 3.

2. The process as claimed in claim 1, wherein in the formula (I)
R¹ is an aromatic hydrocarbon radical having at least 6 carbon atoms or is a linear, branched, substituted or unsubstituted aliphatic hydrocarbon radical having at least 3 carbon atoms;
R² is a linear, branched, substituted or unsubstituted aliphatic hydrocarbon radical having at least 3 carbon atoms; and
n is 1 to 3.

3. The process as claimed in claim 1, wherein component A comprises:
A1 40 to 100 parts by weight of one or more polyether polyols having a hydroxyl value in accordance with DIN 53240-1:2013-06 from 20 mg KOH/g to 250 mg KOH/g and an ethylene oxide content of 0.10% to 59.0% by weight,
A2 0 to 60 parts by weight of one or more polyether carbonate polyols having a hydroxyl value in accordance with DIN 53240-1:2013-06 from 20 mg KOH/g to 120 mg KOH/g,
A3 0 to 60 parts by weight, based on a sum of the parts by weight of components A1 and A2, of one or more polyether polyols having a hydroxyl value in accordance with DIN 53240-1:2013-06 from 20 mg KOH/g to 250 mg KOH/g and an ethylene oxide content of at least 60% by weight,
A4 0 to 40 parts by weight, based on the sum of the parts by weight of components A1 and A2, of one or more polymer polyols, PUD polyols, PIPA polyols, or a combination thereof, and
A5 0 to 40 parts by weight, based on the sum of the parts by weight of components A1 and A2, of polyols that are different from components A1 to A4, wherein all stated parts by weight of components A1, A2, A3, A4, A5 are normalized so that A1+A2 in the composition is 100.

4. The process as claimed in claim 1, wherein the at least one compound E is used in an amount of 1.0 to 15.0 parts by weight, wherein all stated parts by weight of compound E are based on 100 parts by weight of component A1.

5. The process as claimed in claim 1, wherein component B comprises:
B1 catalysts comprisinq
a) aliphatic tertiary amines, cycloaliphatic tertiary amines, aliphatic amino ethers, cycloaliphatic amino ethers, aliphatic amidines, cycloaliphatic amidines, urea or urea derivatives, or a combination thereof, and/or
b) tin(II) salts of carboxylic acids, and
B2 optionally auxiliaries and additives.

6. The process as claimed in claim 1, wherein component A comprises:
A1 75 to 100 parts by weight of one or more polyether polyols having a hydroxyl value in accordance with DIN 53240 from 20 mg KOH/g to 250 mg KOH/g and an ethylene oxide content from 0.10% to 59.0% by weight, wherein A1 is free of carbonate units; and
A2 0 to 25 parts by weight of one or more polyether carbonate polyols having a hydroxyl value in accordance with DIN 53240-1:2013-06 from 20 mg KOH/g to 120 mg KOH/g or
A3 0 to 25 parts by weight of one or more polyether polyols having a hydroxyl value in accordance with DIN 53240-1:2013-06 from 20 mg KOH/g to 250 mg KOH/g and an ethylene oxide content of at least 60% by weight.

7. The process as claimed in claim 1, wherein component A further comprises component A2, wherein component A2 comprises a polyether carbonate polyol obtained by copolymerization of carbon dioxide and one or more alkylene oxides in the presence of one or more H-functional starter molecules.

8. The process as claimed in claim 1, wherein component D comprises at least 50% by weight of tolylene 2,4-diisocyanate and tolylene 2,6-diisocyanate.

9. The process as claimed in claim 1, wherein component D comprises not more than 26.5% by weight of tolylene 2,6-diisocyanate, based on a total weight of component D.

10. The process as claimed in claim 9, wherein tolylene 2,4-diisocyanate and tolylene 2,6-diisocyanate are used in a form of a mixture of at least two batches different from one another, wherein a first batch comprises tolylene 2,4-diisocyanate and tolylene 2,6-diisocyanate in a ratio of 80% by weight to 20% by weight and a second batch comprises tolylene 2,4-diisocyanate and tolylene 2,6-diisocyanate in a ratio of 67% by weight to 33% by weight, wherein a proportion of the second batch is not more than 50% by weight, based on a total weight of the first and the second batch.

11. The process as claimed in claim 1, wherein production is carried out at an index of 100 to 115.

12. A polyurethane foam having a density in accordance with DIN EN ISO 845:2009-10 from 50.0 to 80.0 kg/m³ obtained by the process as claimed in claim 1.

13. The polyurethane foam as claimed in claim 12, wherein the polyurethane foam is an open-cell flexible polyurethane foam.

14. A method of producing an automobile component, comprising producing an automobile component comprising one or more of furniture cushioning, textile inserts, mattresses, automobile seats, headrests, armrests, sponges, foam films, wherein the automobile component comprises the polyurethane foam of claim 12.

15. A two-component system for producing polyurethane foams having a density in accordance with DIN EN ISO 845:2009-10 from 50.0 to 80.0 kg/m³ comprising
a first component K1 comprising:
component A) comprising one or more polyether polyols A1,
B) optionally
B1) catalysts, and/or
B2) auxiliaries and additives,
C water and/or physical blowing agents, and
E) a compound that has the formula (I) below: 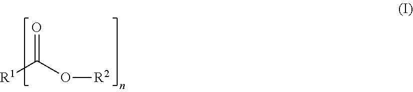
where
R¹ is an aromatic hydrocarbon radical having at least 5 carbon atoms or is a linear, branched, substituted or unsubstituted aliphatic hydrocarbon radical having at least 2 carbon atoms;
R² is a linear, branched, substituted or unsubstituted aliphatic hydrocarbon radical; and
n is 1 to 3,
and a second component K2 comprising:
D) di- and/or polyisocyanates that comprise tolylene 2,4-diisocyanate and tolylene 2,6-diisocyanate,
and at least one catalyst, wherein component K1 and component K2 are present in a ratio of an isocyanate index of 90 to 120.
